(19) United States
(12) Patent Application Publication
(10) Pub. No.: US 2011/0302102 A1
(43) Pub. Date: Dec. 8, 2011

(54) COMMUNITY RATING AND RANKING IN ENTERPRISE APPLICATIONS

(75) Inventors: Chandra Yeleshwarapu, Foster City, CA (US); Keshava Rangarajan, Foster City, CA (US); Sudeep Agarwal, San Francisco, CA (US); Athanasios Bismpigiannis, Sunnyvale, CA (US); Nagaraj Srinivasan, Union City, CA (US); Aditya Ramamurthy Rao, Mysore (IN); Narni Rajesh, Hyderabad (IN); Bhaskar Jyoti Ghosh, Patna (IN)

(73) Assignee: Oracle International Corporation, Redwood Shores, CA (US)

(21) Appl. No.: 12/793,375

(22) Filed: Jun. 3, 2010

(51) Int. Cl. G06Q 99/00

(52) U.S. Cl. 705/347

(57) ABSTRACT

The present invention is directed to methods and systems which provide a comprehensive rating and ranking of products and services. Furthermore, aspects of the present invention provides a complete review of products and services, as well as rankings of semantic and non-semantic reviews, which provides a “true” reflection of a product and/or service. As such, a calculation of a product/supplier rating based on all of its social entity contexts, is performed. This takes into account factors like, author (of social entity context) credibility, non-semantic (direct) rating, semantic rating calculated from the textual content of the social entity context, the community based credibility of the social entity context, and the like. Then, the community based credibility of a given social entity context is in turn calculated.

### CROSS-REFERENCES TO RELATED APPLICATIONS

This application relates to U.S. patent application Ser. No. ______, Attorney Docket No. 021756-097800US, entitled PRODUCT CLASSIFICATION IN PROCUREMENT SYSTEMS, filed on ______, U.S. patent application Ser. No. ______, Attorney Docket No. 021756-097900US, entitled METHOD AND SYSTEM FOR PROVIDING DECISION MAKING BASED ON SENSE AND RESPOND, filed on ______, U.S. patent application Ser. No. ______ Attorney Docket No. 021756-097700US, entitled METHOD AND SYSTEM FOR PROVIDING ENTERPRISE PROCUREMENT NETWORK, filed on ______, which are incorporated by reference in their entirety for any and all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

Currently, product rating and rankings are performed in an arbitrary and ad hoc manner. Such ratings and rankings provide an incomplete and often unreliable review of products and/or services. Furthermore, many of the reviews are spread among a variety of disconnected sources, such that the possibility of forming a complete view of a product of service rating and ranking, is impossible. Hence, improved rating and ranking methods and systems are needed in the art.

### SUMMARY OF THE INVENTION

The present invention is directed to methods and systems which provide a comprehensive rating and ranking of products and services. Furthermore, aspects of the present invention provides a complete review of products and services, as well as rankings of semantic and non-semantic reviews, which provides a “true” reflection of a product and/or service. As such, a calculation of a product/supplier rating based on all of its social entity contexts, is performed. This takes into account factors like, author (of social entity context) credibility, non-semantic (direct) rating, semantic rating calculated from the textual content of the social entity context, the community based credibility of the social entity context, and the like. Then, the community based credibility of a given social entity context is in turn calculated. This is based on comments received from various users within the community. Factors, such as commenter/reviewer credibility, non-semantic (direct) rating given to the social entity context, semantic rating calculated from the text content of the comment, etc., are taken into account. The result includes a comprehensive rating and ranking of the product and/or service.

### BRIEF DESCRIPTION OF THE DRAWINGS

FIG. 1 is a simplified flow diagram illustrating a method 100, according to an embodiment of the present invention.

FIG. 2 is a simplified block diagram illustrating a system 200, according to an embodiment of the present invention.

FIG. 3 is a simplified block diagram illustrating weight factors, according to an embodiment of the present invention.

FIG. 4 is a simplified block diagram illustrating a ranking table, according to an embodiment of the present invention.

FIG. 5 is a simplified block diagram illustrating a ranking table, according to a further embodiment of the present invention.

FIG. 6 is a simplified block diagram illustrating a system 600, according to an embodiment of the present invention.

FIG. 7 is a simplified block diagram illustrating physical components of a system environment 700 that may be used in accordance with an embodiment of the present invention.

FIG. 8 is a simplified block diagram illustrating the physical components of a computer system 800 that may be used in accordance with an embodiment of the present invention.

### DETAILED DESCRIPTION OF THE INVENTION

The present invention is directed to methods and systems which provide a comprehensive rating and ranking of products and services. Furthermore, aspects of the present invention provides a complete review of products and services, as well as rankings of semantic and non-semantic reviews, which provides a “true” reflection of a product and/or service. As such, a calculation of a product/supplier rating based on all of its social entity contexts, is performed. This takes into account factors like, author (of social entity context) credibility, non-semantic (direct) rating, semantic rating calculated from the textual content of the social entity context, the community based credibility of the social entity context, and the like. Then, the community based credibility of a given social entity context is in turn calculated. This is based on comments received from various users within the community. Factors, such as commenter/reviewer credibility, non-semantic (direct) rating given to the social entity context, semantic rating calculated from the text content of the comment, etc., are taken into account. The result includes a comprehensive rating and ranking of the product and/or service.

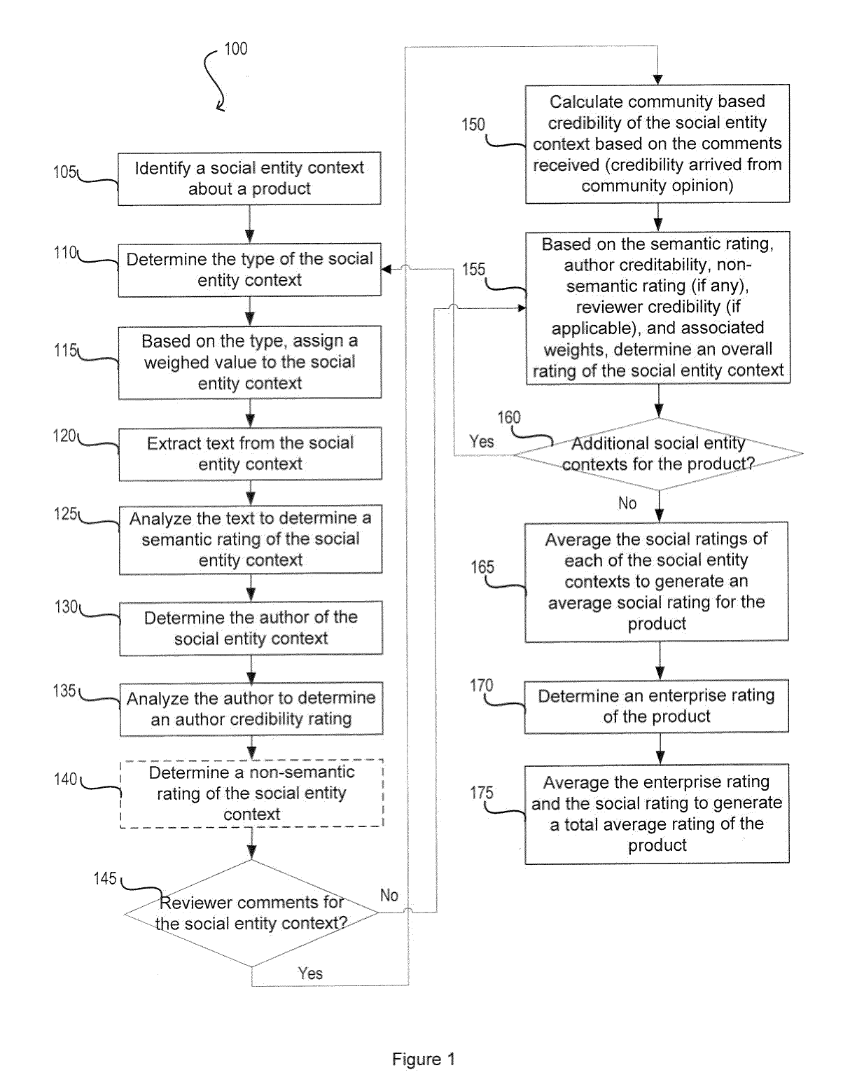

Turning now to FIG. 1, which illustrates a method 100, according to an embodiment of the present invention. At process block 105, identification of one or more social entity contexts about a product, service, or supplier. In one embodiment, a social entity context may include a blog post, a recommendation, a wiki article, a review, a poll, a thread post, a forum post, a mail message, an instant message, etc. In other words, a social entity context is any medium for which semantic or non-semantic comments may be made about a product, a service, or a supplier.

In one embodiment, a non-semantic comment includes comments for which a direct rating may be ascertained. For example, a “thumbs up or thumbs down” rating, a 1-10 scaled rating, etc. In a further embodiment, a semantic rating includes a rating that is inferred by the context of textual comments. For example, the text of a review post is parsed and analyzed to determine the tone, bias, rating, etc. of the review post. In other words, a semantic rating is a subjective standard, while a non-semantic rating is an objective standard.

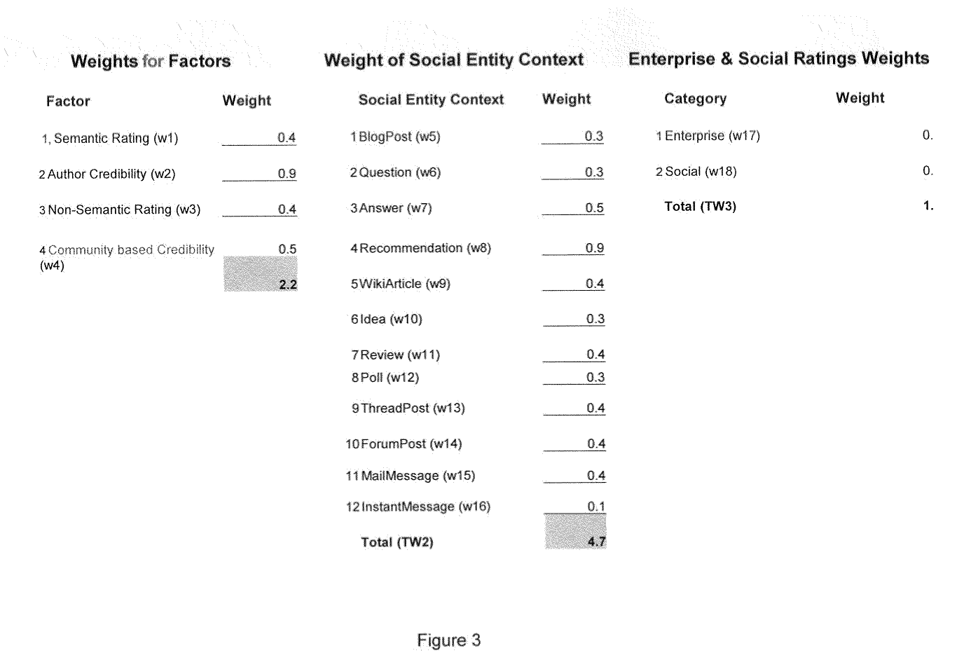

At process block 110, a determination of the type of the social entity context is performed. For example, is may be determined that the type of the social entity context is a blog post or alternatively a poll. Then, based on the type of the social entity context, a weighted value is assigned to the social entity context (see the table in FIG. 3). Each type of social entity context may have a specific weight value (process block 115). For example, a recommendation may be weighted higher than an instance message, based on the usefulness, credibility, reliability, etc. of a recommendation as opposed to an instant message. These weights may initially be seeded, but they may then automatically evolve over time based on data and other factors.

Further, at process block 120, the text (or other data) of the social entity context may be extracted (or parsed). The extracted text (or other data) or the social entity context may then be analyzed to determine a semantic rating of the social entity context (process block 125). For example, the text may include 5 to 1 positive words or phrases, which may in turn generate a positive semantic rating.

In addition to the text of the social entity context, the author of the social entity context may also be important in determining an overall rating of the social entity context. As such, the author of the social entity context may be determined (process block 130), and then an analysis of the author may be performed in order to determine the author's credibility (process block 135). In one embodiment, the author's credibility may be based on the number of post by the author, the length of time the author has been posting, the rating and reviews of the author's posts by others within the community, and so forth.

At process block 140, a non-semantic rating, if any, of the social entity context may be determined. In one embodiment, a non-semantic rating may not exist for a given social entity context. For example, the social entity context may not include a numeric (or other definitive) rating which can be extracted from the social entity context. In that situation, no non-semantic rating for the social entity context would be determined.

Furthermore, at decision block 145, a determination is made whether the social entity context has reviewer comments. If the social entity context has review comments, then at process block 150, a community based credibility of the social entity context is calculated. In one embodiment, this calculation is based on the comments received from the community about the social entity context (i.e., credibility arrived from the community opinion). If no comments are found. then method 100 moves to process block 155.

At process block 155, based on the semantic rating, non-semantic rating, author credibility, reviewer credibility, and the associated weights of each, the overall rating of the social entity context is determined.

At decision block 160, a determination is made whether additional social entity contexts exist for the product, service, or supplier. If additional social entity contexts exist, then method 100 returns to process block 110, and repeats process blocks 110-155 for each of the additional social entity contexts. Once all of the social entity contexts for the product, service, or supplier have been rated, an average of the ratings for the social entity contexts is calculated (process block 165). Such an average provides a total social rating for the product, service, or supplier.

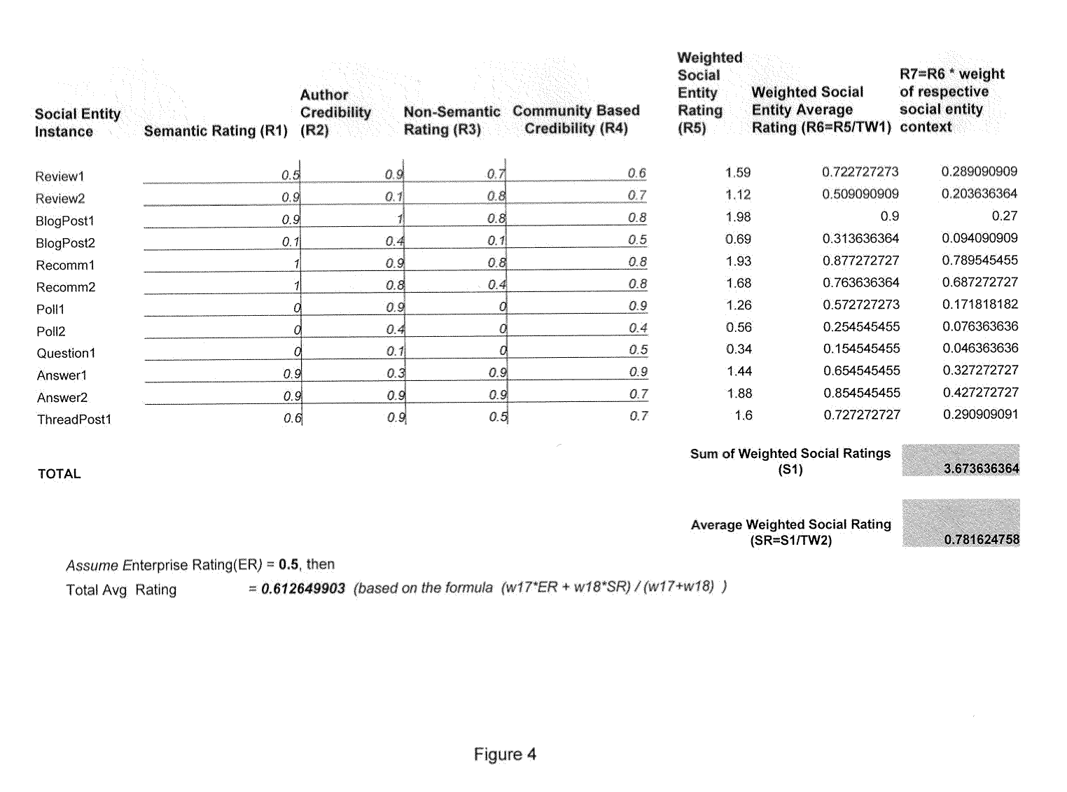

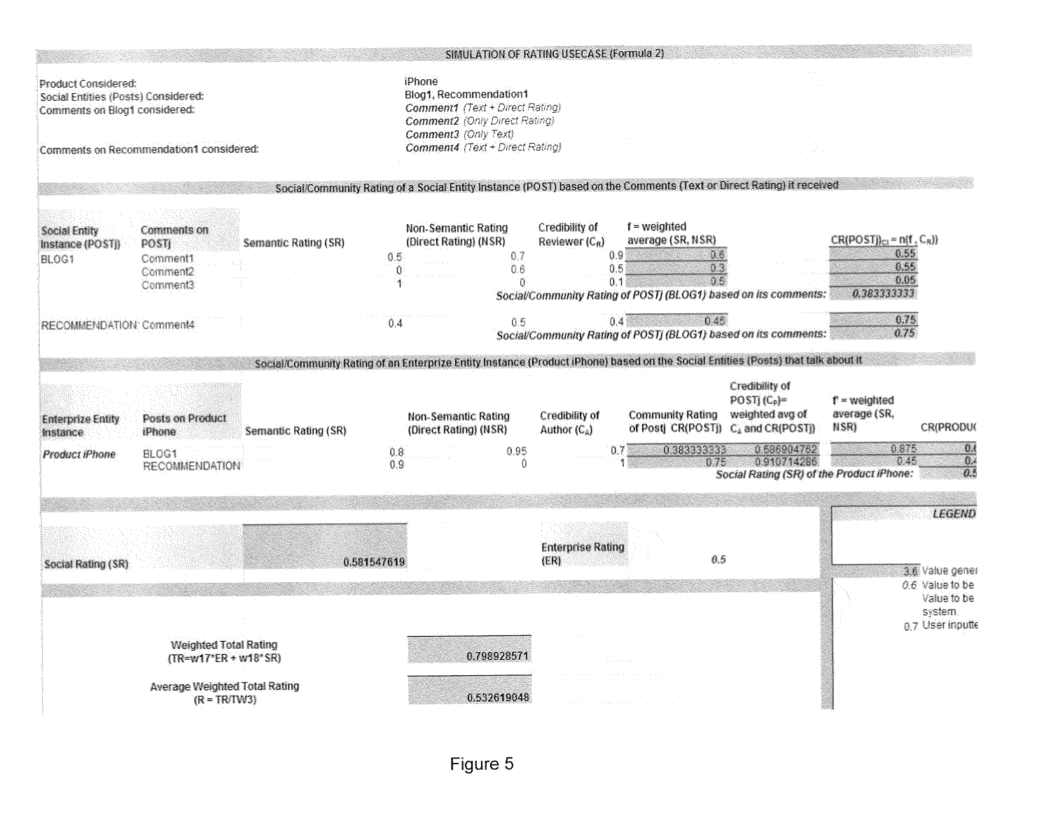

In addition to the social rating of a product, service, or supplier, an enterprise rating may also be determined (process block 170). In one embodiment, an enterprise rating includes ratings based on sales, product specifications, testing results, etc. at process block 175, an average of the social rating and the enterprise rating of the product, service, or supplier may be calculated to determine a total average rating of the product, service, or supplier. FIGS. 4 and 5, and tables 1 and 2 provide examples of the calculations and formulas that may be used to determine such total average ratings of a product, service, or supplier. The tables in FIGS. 4 and 5, and tables 1 and 2 will be described below in more detail.

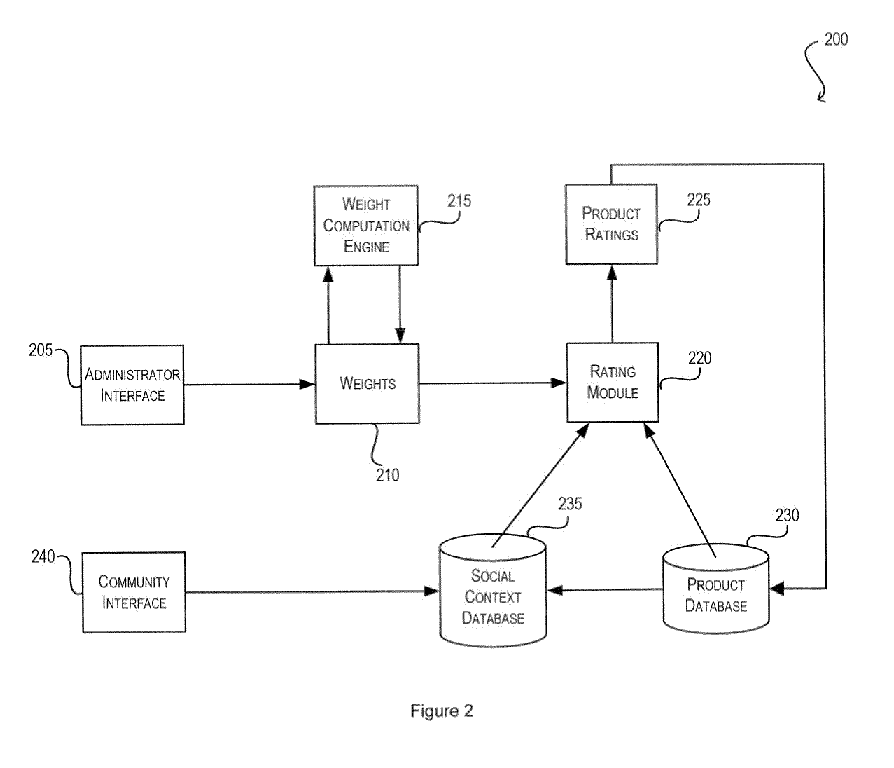

Turning next to FIG. 2, which illustrates a system 200, according to an embodiment of the present invention. In one embodiment, system 200 may include an administrator interface 205. An administrator (or similar entity) may use the administrator interface 205 to assign weights to the various rating factors and social entity context types (see FIG. 3). In weights 210, the assigned weights of each factor and context type may be stored. Further, weight computation engine 215 may retrieve the assignments from the administrator interface 205 and computer the updated weights, which are then stored in weights 210.

In a further embodiment, system 200 may include a rating module 220. The rating module 220 may be configured to implement the rating process described above with regard to method 100 in FIG. 1. The rating module is in communication with a social context database 235 and a products database 230. In one embodiment, the social context database 235 is a compilation of all of the social entity contexts generated for all of the products stored in the product database 230. Furthermore, social context database 235 receives additional social entry contexts about the products in product database 230 from the community via the community interface 240. Accordingly, the product ratings determined by the rating module 220 are stored in product ratings 225.

Referring now to FIG. 3, which illustrates a table of weight factors, according to an embodiment of the present invention. It should be noted that the weights applied are merely for explanation purposes, and are not intended to be limiting in any way. FIG. 3 shows the weights of various factors that are involved rating computation. These weights can be initially seeded by a domain expert/admin user, but are allowed to automatically evolve/change over time based on the data and other factors. Many changes and adjustments to the weights may be made. In one embodiment, the table includes weight for factors, where the factors include semantic ratings, author credibility, non-semantic ratings, and community based credibility. FIG. 3 further includes weights of social entity contexts. The social entity contexts may include blog posts, questions, answers, recommendations, wiki articles, ideas, reviews, polls, thread posts, forum posts, mail messages, instant messages, etc. Each of these social entity contexts may also be weighted. Furthermore, FIG. 3 may include weights for enterprise and social ratings. Accordingly, the weight values include in the table of FIG. 3 may be used in method 100 of FIG. 1 to determine a total average ratings of a product, service, or supplier.

FIG. 4 illustrates a ranking table, according to an embodiment of the present invention. In one embodiment, the table includes calculations of social entity ratings for multiple social entities, as well as application of the weighing for each social entity type. The table further includes the determination of the total average rating of the product, service, or supplier. In one embodiment the following algorithm (table 1) may be used to calculate the values shown in FIG. 4's.

```
TABLE 1
Social Rating of a product contributed by a single social hem S_{Ri} :
  ${S}_{{R}_{i}} = ( \frac{{w}_{1} \cdot {Sm}_{R} + {w}_{2} \cdot {A}_{C} + {w}_{3} \cdot {NSm}_{R} + {w}_{4} \cdot {R}_{C}}{{w}_{1} + {w}_{2} + {w}_{3} + {w}_{4}} )$
    SmR = Semantic Rating of product contributed by social item ‘i’
    Ac = Credibility of author of the social item ‘i’
    NSmR = Non semantic rating of the product given via the social item ‘i’
    Rc = Credibility of the Reviewer
    w1, w2, w3, w4 are corresponding weights
Social Rating of a product based on all its related Social Items S_{R}:
  ${S}_{R} = \frac{{\sum }_{i = 1}^{n} {S}_{{R}_{i}} \cdot {w}_{{E}_{i}}}{{\sum }_{i = 1}^{n} {w}_{{E}_{1}}}$
    w_{E} is the weight of corresponding social entity
Enterprise Rating component E_{R} is calculated using the product's corporate
compliance, recency etc.
Final Rating E_{(R)} the Product is the weighted average of social and enterprise
rating components a shown below:
  ${E}_{( R )} = \frac{{w}_{{E}_{R}} \cdot {E}_{R} + {w}_{{S}_{R}} \cdot {S}_{R}}{{w}_{{E}_{R}} + {w}_{{S}_{R}}} .$
```

Turning now to FIG. 5, which illustrates a ranking table, according to a further embodiment of the present invention. In one embodiment, the table includes calculations of social entity ratings for multiple social entities, as well as application of the weighing for each social entity type. The table further includes the determination of the total average rating of the product, service, or supplier. In one embodiment the following algorithm (table 2) may be used to calculate the values shown in FIG. 5's table.

TABLE 2
Rating of Postⱼ based on the comment Cᵢ.
R_{POSTj}_{_{Ci}} = η(ƒ(SR_{POSTj}_{_{Ci}}, NSR_{POSTj}_{_{Ci}}), C_{Ci})

| | |
|---|---|
| SR_{POSTj}_{_{Ci}} | → Semantic Rating of POSTⱼ based on Cᵢ (Comment on POSTⱼ) |
| NSR_{POSTj}_{_{Ci}} | → Non Semantic Rating of POSTⱼ based on Cᵢ (Comment on POSTⱼ) |
| C_{Ci} | → Credibility of Ci = Credibility of Author of Ci = C(RA_{Ci}) |

```
Social/Community Rating of the Postⱼ:
  ${CR}_{POSTj} = {g}_{i = 1}^{N} ( {R}_{{POSTj}_{Ci}} )$
    Where ƒ · g is weighted average function.
Rating of Product p based on Postj:
  R_{PRODUCTp}_{_{POSTj}} = η′(ƒ′(SR_{PRODUCTp}_{_{POSTj}}, NSR_{PRODUCTp}_{_{POSTj}}), C_{POSTj})
```

| | |
|---|---|
| SR_{PRODUCTp}_{_{POSTj}} | → Semantic Rating of PRODUCTₚ based on POSTⱼ |
| NSR_{PRODUCTp}_{_{POSTj}} | → Non Semantic (Direct) Rating of PRODUCTₚ based on POSTⱼ) |
| C_{POSTj} | → Credibility of POSTj = h ( Credibility of Author of POSTj , |

```
Community Rating of POSTⱼ ) = h(C(A), CRPOSTⱼ)
Social/Community Rating of Product p based on an all posts:
  ${CR}_{PROCUCTp} = {{g}^{′}}_{j = 1}^{M} ( {R}_{{PRODUCTp}_{POSTj}} )$
    where ƒ′ · g′ is a simple weighted average function
    Where η and η′ are Normalization Functions [that normalizes the value towards
    the base or the mean value, based on the credibility]
  And
    $η ( v , C ) = \{ \begin{matrix}v - ( {C}_{MAX} - C ) \times {C}_{BASE} , if v \geq {C}_{BASE} \\ v + ( {C}_{MAX} - C ) \times {C}_{BASE} , if v < {C}_{BASE}\end{matrix}$
    v = value to be normalized towards the base value,
    C = Credibility that determines the extent, the normalization has to be done,
    CMAX = Maximum permitted value of Credibility,
    CBASE = Base (middle) value of Credibility
    NOTE: If range of credibility is 0-10, then CMAX = 10 and CBASE = 5
```

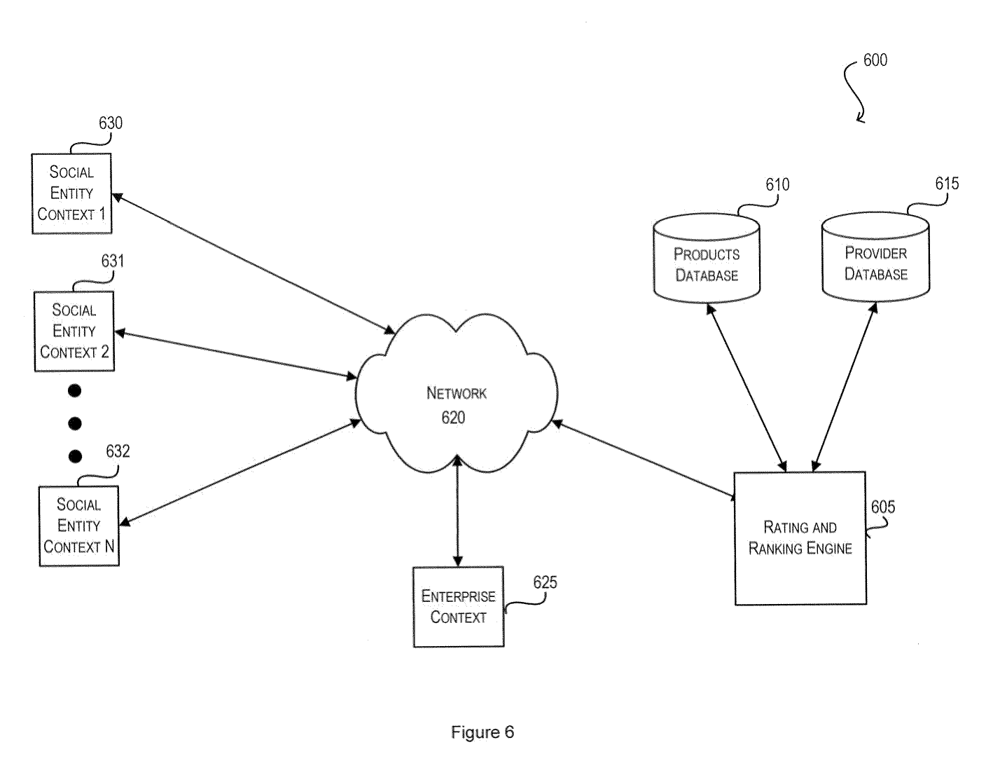

Turning next to FIG. 6, which illustrates a system 600, according to an embodiment of the present invention. In one embodiment, system 600 may include multiple social entity contexts 630, 631 to 632. These social entity contexts are in communication with a rating and ranking system 605 via a network 620. Based on the entity contexts 630-632, an enterprise context 625, a products database 610, and a provider database 615, the rating and ranking system 605 determines a total average ratings of a product, service, or supplier, using method 100 from FIG. 1.

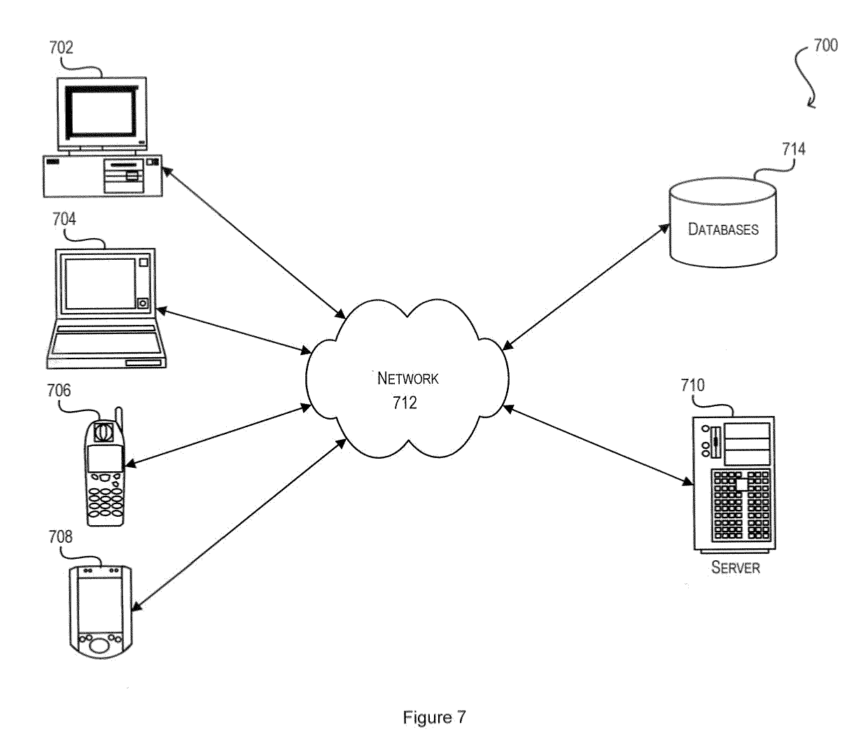

FIG. 7 is a simplified block diagram illustrating physical components of a system environment 700 that may be used in accordance with an embodiment of the present invention. This diagram is merely an example, which should not unduly limit the scope of the claims. One of ordinary skill in the art would recognize many variations, alternatives, and modifications.

As shown, system environment 700 includes one or more client computing devices 702, 704, 706, 708 communicatively coupled with a server computer 710 via a network 712. In one set of embodiments, client computing devices 702, 704, 706, 708 may be configured to run one or more components of a graphical user interface described above. For example, client computing devices allow user to create and customize network communities, enter search queries, view search results, and others.

Client computing devices 702, 704, 706, 708 may be general purpose personal computers (including, for example, personal computers and/or laptop computers running various versions of Microsoft Windows™ and/or Apple Macintosh™ operating systems), cell phones or PDAs (running software such as Microsoft Windows' Mobile and being Internet, e-mail, SMS, Blackberry™, and/or other communication protocol enabled), and/or workstation computers running any of a variety of commercially-available UNIX™ or UNIX™-like operating systems (including without limitation the variety of GNU/Linux™ operating systems). Alternatively, client computing devices 702, 704, 706, and 708 may be any other electronic device capable of communicating over a network (e.g., network 712 described below) with server computer 710. Although system environment 700 is shown with four client computing devices and one server computer, any number of client computing devices and server computers may be supported.

Server computer 710 may be a general purpose computer, specialized server computer (including, e.g., a LINUX™ server, UNIX™ server, mid-range server, mainframe computer, rack-mounted server, etc.), server farm, server cluster, or any other appropriate arrangement and/or combination. Server computer 710 may run an operating system including any of those discussed above, as well as any commercially available server operating system. Server computer 710 may also run any of a variety of server applications and/or mid-tier applications, including web servers, Java virtual machines, application servers, database servers, and the like. In various embodiments, server computer 710 is adapted to run one or more Web services or software applications described in the foregoing disclosure. For example, server computer 710 is specifically configured to implemented enterprise procurement systems described above.

As shown, client computing devices 702, 704, 706, 708 and server computer 710 are communicatively coupled via network 712. Network 712 may be any type of network that can support data communications using any of a variety of commercially-available protocols, including without limitation TCP/IP, SNA, IPX, AppleTalk™, and the like. Merely by way of example, network 712 may be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth™ protocol known in the art, and/or any other wireless protocol); and/or any combination of these and/or other networks. In various embodiments, the client computing devices 702, 704, 706, 708 and server computer 710 are able to access the database 714 through the network 712. In certain embodiments, the client computing devices 702, 704, 706, 708 and server computer 710 each has its own database.

System environment 700 may also include one or more databases 714. Database 714 may correspond to an instance of integration repository as well as any other type of database or data storage component described in this disclosure. Database 714 may reside in a variety of locations. By way of example, database 714 may reside on a storage medium local to (and/or resident in) one or more of the computing devices 702, 704, 706, 708, or server computer 710. Alternatively, database 714 may be remote from any or all of the computing devices 702, 704, 706, 708, or server computer 710 and/or in communication (e.g., via network 712) with one or more of these. In one set of embodiments, database 714 may reside in a storage-area network (SAN) familiar to those skilled in the art. Similarly, any necessary files for performing the functions attributed to the computing devices 702, 704, 706, 708, or server computer 710 may be stored locally on the respective computer and/or remotely on database 714, as appropriate. For example the database 714 stores user profiles, procurement information, attributes associated with network entities.

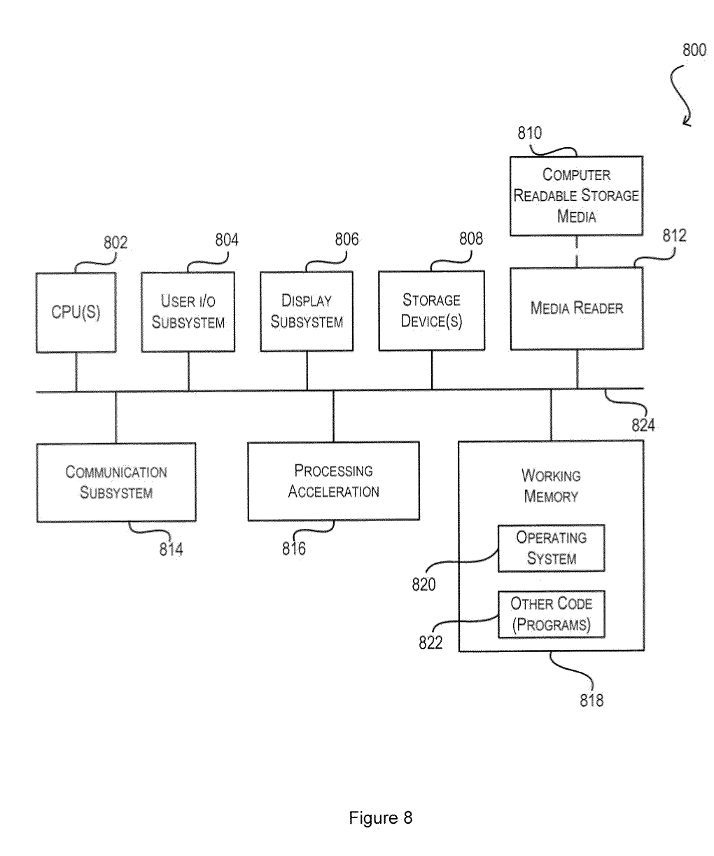

FIG. 8 is a simplified block diagram illustrating the physical components of a computer system 800 that may be used in accordance with an embodiment of the present invention. This diagram is merely an example, which should not unduly limit the scope of the claims. One of ordinary skill in the art would recognize many variations, alternatives, and modifications.

In various embodiments, computer system 800 may be used to implement any of the computing devices 702, 704, 706, 708, or server computer 710 illustrated in system environment 700 described above. As shown in FIG. 8, computer system 800 comprises hardware elements that may be electrically coupled via a bus 824. The hardware elements may include one or more central processing units (CPUs) 802, one or more input devices 804 (e.g., a mouse, a keyboard, etc.). and one or more output devices 806 (e.g., a display device, a printer, etc.). For example, the input devices 804 are used to receive user inputs for procurement related search queries. Computer system 800 may also include one or more storage devices 808. By way of example, storage devices 808 may include devices such as disk drives, optical storage devices, and solid-state storage devices such as a random access memory (RAM) and/or a read-only memory (ROM), which can be programmable, flash-updateable and/or the like. In an embodiment, various databases are stored in the storage devices 808. For example, the central processing units 802 is configured to retrieve data from a database and process the data for displaying on a GUI.

Computer system 800 may additionally include a computer-readable storage media reader 812, a communications subsystem 814 (e.g., a modem, a network card (wireless or wired), an infra-red communication device, etc.), and working memory 818, which may include RAM and ROM devices as described above. In some embodiments, computer system 800 may also include a processing acceleration unit 816, which can include a digital signal processor (DSP), a special-purpose processor, and/or the like.

Computer-readable storage media reader 812 can further be connected to a computer-readable storage medium 810, together (and, optionally, in combination with storage devices 808) comprehensively representing remote, local, fixed, and/or removable storage devices plus storage media for temporarily and/or more permanently containing computer-readable information. Communications system 814 may permit data to be exchanged with network 712 of FIG. 7 and/or any other computer described above with respect to system environment 700.

Computer system 800 may also comprise software elements, shown as being currently located within working memory 818, including an operating system 820 and/or other code 822, such as an application program (which may be a client application, Web browser, mid-tier application, RDBMS, etc.). In a particular embodiment, working memory 818 may include executable code and associated data structures for one or more of the design-time or runtime components/services illustrated in FIGS. 3 and 6. It should be appreciated that alternative embodiments of computer system 800 may have numerous variations from that described above. For example, customized hardware might also be used and/or particular elements might be implemented in hardware, software (including portable software, such as applets), or both. Further, connection to other computing devices such as network input/output devices may be employed. In various embodiments, the behavior of the view functions described throughout the present application is implemented as software elements of the computer system 800.

In one set of embodiments, the techniques described herein may be implemented as program code executable by a computer system (such as a computer system 800) and may be stored on machine-readable media. Machine-readable media may include any appropriate media known or used in the art, including storage media and communication media, such as (but not limited to) volatile and non-volatile, removable and non-removable media implemented in any method or technology for storage and/or transmission of information such as machine-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store or transmit the desired information and which can be accessed by a computer.

Although specific embodiments of the present invention have been described, various modifications, alterations, alternative constructions, and equivalents are within the scope of the invention. Further, while embodiments of the present invention have been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

1. A computer system, comprising:
one or more processors; and
a storage device in communication with the one or more processors, wherein a rating and ranking system implemented by a rating and ranking application which is stored on the storage device, comprising a storage medium having a set of instructions stored thereon, executable by the one or more processors to perform the following operations:
identify a social entity context from a plurality of social entity contexts about a product;
determine a type of the social entity context;
based on the type of the social entity context, assign a weighted value to the first social entity context;
extract text from the social entity context;
analyze the extracted text from the social entity context to determine a semantic rating for the social entity context;
determine the social entity context's author;
analyze the author to determine an author credibility rating for the author;
determine a non-semantic rating of the social entity context;
analyze one or more reviewers of the social entity context;
based on the semantic rating, author credibility rating, non-semantic rating, the one or more reviewers credibility rating, and the assigned weight, determine an overall rating of the social entity context;
based on an average of the overall rating of the social entity context and the plurality of social entity contexts, determine a social rating for the product;
determine an enterprise rating of the product; and
average the enterprise rating and the social rating of the product and generate a total rating for the product.

2. The computer system of claim 1, the rating and ranking application further comprises sets of instructions which, when executed by the one or more processors, cause the one or more processors to perform the operation of calculating a community based credibility of the social entity context based on the comments received.

3. The computer system of claim 2, wherein community based credibility of the social entity context comprises credibility arrived from community opinion.

4. The computer system of claim 1, wherein the weights are initially seeded.

5. The computer system of claim 4, wherein after the seeding of the weights, the weights automatically evolve over time based on data retrieved.

6. The computer system of claim 4, wherein the initial seeding is initiated by a system administrator.

7. The computer system of claim 1, wherein the social entity context comprises one or more of the following: a blog post, a recommendation, an article, a review, a thread post, a forum post, a mail message, and an instant message.

8. The computer system of claim 1, wherein the semantic rating comprises a rating which has inferred relevance.

9. The computer system of claim 1, wherein the non-semantic rating comprises a rating which has a direct rating.

10. The computer system of claim 1, further comprising a weight computation engine coupled with the rating and ranking system, the weight computation engine configured to compute the weighted values.

11. A computer-readable medium having sets of instructions stored thereon which, when executed by a computer, cause the computer to:
identify a social entity context from a plurality of social entity contexts about a product;
determine a type of the social entity context;
based on the type of the social entity context, assign a weighted value to a first social entity context;
extract text from the social entity context;
analyze the extracted text from the social entity context to determine a semantic rating for the social entity context;
determine the social entity context's author;
analyze the author to determine an author credibility rating for the author;
determine a non-semantic rating of the social entity context;
analyze one or more reviewers of the social entity context;
based on the semantic rating, author credibility rating, non-semantic rating, the one or more reviewers credibility rating, and the assigned weight, determine an overall rating of the social entity context;
based on an average of the overall rating of the social entity context and the plurality of social entity contexts, determine a social rating for the product;
determine an enterprise rating of the product; and
average the enterprise rating and the social rating of the product and generate a total rating for the product.

12. A method of implementing an rating and ranking application, the method comprising:
identifying a social entity context from a plurality of social entity contexts about a product;
determining a type of the social entity context;
based on the type of the social entity context, assigning a weighted value to a first social entity context;
extracting text from the social entity context;
analyzing the extracted text from the social entity context to determine a semantic rating for the social entity context;
determining the social entity context's author;
analyzing the author to determine an author credibility rating for the author;
determining a non-semantic rating of the social entity context;
analyzing one or more reviewers of the social entity context;
based on the semantic rating, author credibility rating, non-semantic rating, the one or more reviewers credibility rating, and the assigned weight, determining an overall rating of the social entity context;
based on an average of the overall rating of the social entity context and the plurality of social entity contexts, determining a social rating for the product;
determining an enterprise rating of the product; and
averaging the enterprise rating and the social rating of the product and generating a total rating for the product.

13. The method of claim 12, further comprising calculating a community based credibility of the social entity context based on the comments received.

14. The method of claim 13, wherein community based credibility of the social entity context comprises credibility arrived from community opinion.

15. The method of claim 12, wherein the weights are initially seeded.

16. The method of claim 15, wherein after the seeding of the weights, the weights automatically evolve over time based on data retrieved.

17. The method of claim 15, wherein the initial seeding is initiated by a system administrator.

18. The method of claim 12, further comprising computing the weighted values.

19. The method of claim 12, wherein the semantic rating comprises a rating which has inferred relevance.

20. The method of claim 12, wherein the non-semantic rating comprises a rating which has a direct rating.
